(19) United States
(12) Patent Application Publication
(10) Pub. No.: US 2019/0381866 A1
(43) Pub. Date: Dec. 19, 2019

(54) Vehicle Having A Two-Stage Cooling System

(71) Applicant: SIEMENS MOBILITY GMBH, MUENCHEN (DE)

(72) Inventors: THOMAS KUEBECK, GREFRATH (DE); FRANK KEMMERLING, NEUSS (DE)

(21) Appl. No.: 16/480,328

(22) PCT Filed: Jan. 4, 2018
(86) PCT No.: PCT/EP2018/050202

§ 371 Date: Jul. 24, 2019

(30) Foreign Application Priority Data
Jan. 25, 2017 (DE) 10 2017 201 186.6

(51) Int. Cl. B60H 1/32

(52) U.S. Cl. CPC B60H 1/32281

(57) ABSTRACT

A high-capacity vehicle includes a vehicle floor and at least one refrigeration machine which is disposed under the vehicle floor and has a first refrigerant circuit. A second refrigerant circuit extends at least partially inside the vehicle. An intermediate heat exchanger is provided for heat exchange between the first refrigerant circuit and the second refrigerant circuit.

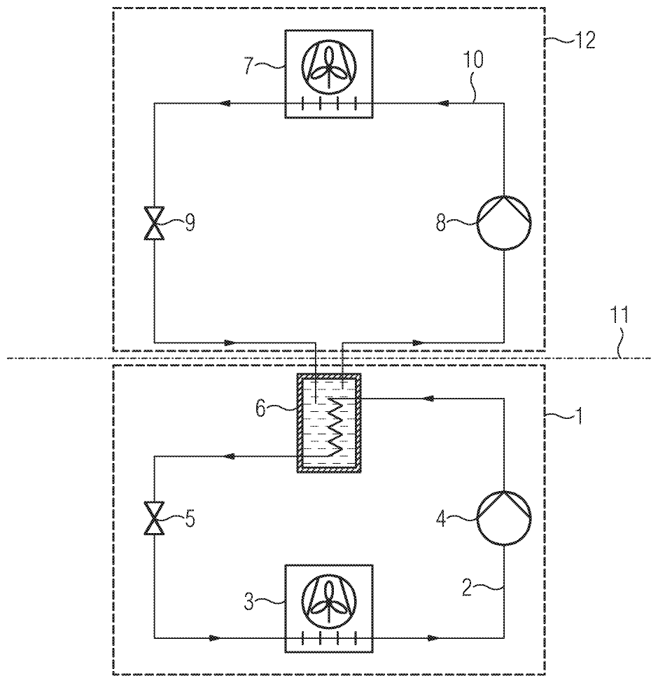

The invention relates to a high-capacity vehicle having at least one refrigeration machine having a first refrigerant circuit.

In refrigeration machines for cooling refrigerators of an onboard kitchen in passenger transport vehicles, refrigerants such as R134a or R404a, for example, were previously used for refrigeration, the use of which is restricted or prohibited owing to their global warming potential (global warming potential values, abbreviated as GWP values, greater than 150). Further refrigerants, such as the natural refrigerant, propane, or hydrofluoro-olefins HFO1234yf or HFO1234ze, for example, are combustible or form flammable mixtures with air when discharged and therefore cannot be used inside vehicles.

The invention is based on the object of proposing a vehicle having a safe and environmentally friendly refrigeration system.

The object is achieved by the subject matter of independent claim 1. Further developments and configurations of the invention are identified in the features of the dependent claims.

A high-capacity vehicle according to the invention, in particular for passenger transport, for example a rail vehicle, comprises at least one refrigeration machine having at least one first refrigerant circuit, wherein the refrigeration machine, including the first refrigerant circuit, is arranged underfloor. According to the invention, the vehicle henceforth comprises at least one second refrigerant circuit, which is arranged at least partially inside the vehicle, and at least one intermediate heat exchanger for heat exchange between the first refrigerant circuit and the second refrigerant circuit.

It is also possible to speak of a two-stage refrigeration system owing to the two mutually separate refrigerant circuits. The first refrigerant circuit extends in particular exclusively outside an interior space, in particular a passenger space, of the vehicle, whilst at least part of the second refrigerant circuit extends inside the vehicle.

In general, refrigeration machines, in particular compression refrigeration systems, also often referred to as climate control systems, are usually based on a thermodynamic cycle. A refrigerant alternately absorbs heat at a low temperature and releases it again at a higher temperature. Such machines operate either by alternately vaporizing and condensing the refrigerant or with a constantly gaseous medium.

In the cycle, a usually gaseous refrigerant is compressed by a compressor, wherein it is heated. In a heat transfer device connected downstream, it releases heat to the environment, whereby it cools. In this case, the refrigerant can remain in a gaseous state or it condenses. The heat transfer device is then also referred to as a liquefier. Liquid refrigerant is subsequently conducted to a throttle member, where its pressure is reduced. The gaseous refrigerant is also expanded and further cooled, for example in a turbine which can recover some of the energy consumed by the vapor compressor. The refrigerant then absorbs heat from the space to be cooled, for example in a second heat transfer device, in the second case by vaporization at low temperature in a so-called evaporator before it is compressed again. The cycle is therefore closed.

The process can also be configured to be open, in that air is taken in from the environment, compressed, cooled and expanded, after which it is supplied to the space to be cooled.

According to a development of the invention, the first refrigerant circuit is designed as a closed refrigerant circuit. The second refrigerant circuit can also be designed as a closed refrigerant circuit.

The first refrigerant circuit can be referred to as a primary circuit. The second refrigerant circuit can be analogously described as a secondary circuit.

According to a further development of the invention, it is provided that the intermediate heat exchanger is arranged underfloor, in particular in such a way that the first refrigerant circuit is completely underfloor so that the first refrigerant is guided exclusively outside the interior space of the vehicle.

According to a further development, the refrigeration machine is designed as a compression refrigeration system, wherein at least one vapor compressor and/or at least one throttle member are arranged in the first refrigerant circuit. As also developed in the present invention, compressors are conventionally used as vapor compressors. Moreover, the refrigeration machine can have a heat transfer device in the first refrigerant circuit, which acts towards the environment of the vehicle and is arranged accordingly on the vehicle such that it is open to the environment of the vehicle to release heat to the environment, whereby a first refrigerant is cooled in the first refrigerant circuit. Refrigerants can also be referred to as coolants. Refrigerants are substances or mixtures of substances used for removing heat. In this case, a liquid refrigerant is in liquid form at least under laboratory conditions (20° C., 1013 mbar). A gaseous refrigerant would accordingly be in gaseous form at least under laboratory conditions (20° C., 1013 mbar).

A further development of the invention consists in that mutually different refrigerants are used in the first refrigeration circuit and in the second refrigeration circuit. The first and the second refrigerant differ in particular in terms of their chemical structure and/or in terms of their physical properties.

In particular, the second refrigerant is not combustible. The first refrigerant has, in particular, a GWP of below 150. For example, the first refrigerant comprises carbon dioxide or propane or hydrofluoro-olefin. The second refrigerant can be taken from a group of alcohols. It can comprise a glycol, for example.

The refrigeration machine can henceforth have at least one circulating pump in the first refrigerant circuit for delivering the first refrigerant in the first refrigerant circuit.

An, in particular liquid, refrigerant circulating in the first refrigerant circuit is guided through the intermediate heat exchanger as a heat source, is heated during this and releases the absorbed heat to the central cooling system of the refrigeration machine again as a heat sink. The central cooling system of the refrigeration machine in turn includes, in addition to the central heat transfer device, in particular a third heat exchanger, in a development at least one condenser, at least one vapor compressor and at least one evaporator. It henceforth optionally comprises a throttle between the condenser and the evaporator. It can furthermore comprise at least one fan.

The second refrigerant circuit can also have at least one circulating pump for delivering a second refrigerant in the second refrigerant circuit. The circulating pump is developed exclusively for delivering the second refrigerant and is not suitable for compressing the second refrigerant. To regulate the flow of first refrigerant through the at least one intermediate heat exchanger, the vehicle can have, in particular, at least one first valve, which can be arranged, for example, upstream of the specified intermediate heat exchanger in the first refrigerant circuit. Analogously, to regulate the flow of second refrigerant through the at least one intermediate heat exchanger, the vehicle can have at least one second valve, which can be for example upstream of the specified intermediate heat exchanger in the second arranged refrigerant circuit.

According to a further development, the second refrigerant circuit is without a vapor compressor and/or without a condenser and/or without an evaporator. It can also be without a throttle member.

In a further development, the second refrigerant circuit comprises at least one further, second heat exchanger for cooling a refrigerator of an onboard kitchen. It is then designed appropriately and arranged inside the vehicle. A plurality of points to be cooled, and therefore a plurality of second heat exchangers, can also be provided.

According to one embodiment of the invention, the intermediate heat exchanger is designed as a recuperator, in particular as a counter stream heat exchanger, so that the first refrigerant and the second refrigerant stream past one another from opposite directions.

As a result of the two mutually separate refrigerant circuits, refrigerant with a GWP below 150 can be used without additional risk to the passengers. Therefore, combustible refrigerants are optionally arranged outside the passenger area whilst, inside, only low-flammable and therefore harmless refrigerants are used. In the event of a leak in the first refrigerant circuit, the potentially dangerous refrigerant cannot escape into the carriage interior.

The invention permits numerous embodiments. It is explained in more detail with reference to the following FIGURE. This shows a schematic circuit diagram of an inventive two-stage refrigeration system of a vehicle.

The vehicle has a vehicle floor 11, which delimits an interior space of the vehicle towards the bottom. A refrigeration machine 1 having a first refrigerant circuit 2 is arranged exclusively underfloor and therefore underneath the vehicle floor 11.

In the first refrigerant circuit 2, a first refrigerant is guided through various components of the refrigeration machine 1 by means of a pipeline system. Only a central cooling system 3, a first circulating pump 4 for delivering the first refrigerant, a first valve 5 for further controlling the refrigerant flow and an intermediate heat exchanger 6, in which the first refrigerant is heated, are illustrated here.

The central cooling system 3 of the refrigeration machine 1 can comprise a central heat transfer device, for example in the form of a heat exchanger, a condenser, a vapor compressor and an evaporator. It henceforth optionally comprises a throttle between the condenser and the evaporator. It can furthermore comprise at least one fan. The first refrigerant is cooled by means of the central cooling system 3 of the refrigeration machine 1. In this case, the heat is released to the environment of the vehicle in particular by means of the heat transfer device.

A major part of a second refrigerant circuit 10 extends above a floor and therefore inside an area 12 of the vehicle which delimits the interior space, in particular a passenger space, towards the environment, for example a carriage body shell of a rail vehicle.

A second refrigerant is also guided through various components in the second refrigerant circuit 10 by means of a pipeline system. A second circulating pump 8 is provided for delivering the second refrigerant, and a first valve 9 is provided for further controlling the refrigerant flow. The first refrigerant circuit 2 is connected to the second refrigerant circuit 10 via the intermediate heat exchanger 6. The second refrigerant is firstly cooled in the intermediate heat exchanger 6. To this end, it is guided past the first refrigerant, which is heated thereby. The heat from the second refrigerant circuit 10 is transferred to the first refrigerant circuit 2 in the intermediate heat exchanger 6. The intermediate heat exchanger 6 is configured as a counter stream recuperator here.

The cooled second refrigerant is supplied further downstream to a further, second heat exchanger 7, which serves for cooling a refrigerator of an onboard kitchen. In this case, it is in turn heated and conducted to the intermediate heat exchanger again for cooling.

1-10. (canceled)

11. A high-capacity vehicle, comprising:
a vehicle floor;
a vehicle interior disposed above said vehicle floor;
at least one refrigeration machine having a first refrigerant circuit, said at least one refrigeration machine and said first refrigerant circuit being disposed below said vehicle floor;
a second refrigerant circuit extending at least partially into said vehicle interior; and
an intermediate heat exchanger configured for heat exchange between said first refrigerant circuit and said second refrigerant circuit.

12. The vehicle according to claim 11, wherein said at least one refrigeration machine is a compression refrigeration system including at least one of at least one vapor compressor or at least one throttle member disposed in said first refrigerant circuit.

13. The vehicle according to claim 12, wherein said second refrigerant circuit does not have at least one of a vapor compressor or a throttle member.

14. The vehicle according to claim 11, wherein said second refrigerant circuit includes at least one further heat exchanger disposed in said vehicle interior and configured for cooling a refrigerator of an onboard kitchen.

15. The vehicle according to claim 11, wherein said second refrigerant circuit includes at least one circulating pump for delivering a second refrigerant in said second refrigerant circuit.

16. The vehicle according to claim 11, wherein said first refrigerant circuit contains a first refrigerant, said second refrigerant circuit contains a second refrigerant, and said first refrigerant has at least a different chemical structure than said second refrigerant.

17. The vehicle according to claim 11, wherein said first refrigerant circuit contains a first refrigerant, said second refrigerant circuit contains a second refrigerant, and said first refrigerant has different physical properties than said second refrigerant.

18. The vehicle according to claim 11, wherein said first refrigerant circuit contains a first refrigerant, said second refrigerant circuit contains a second refrigerant, and at least one of:
said first refrigerant includes carbon dioxide or propane or a hydrofluoro-olefin, or
said second refrigerant is selected from a group of alcohols.

19. The vehicle according to claim 11, wherein at least one of said first refrigerant circuit or said second refrigerant circuit is closed.

20. The vehicle according to claim 11, wherein said intermediate heat exchanger is disposed below said vehicle floor.
